(19) United States
(12) Patent Application Publication
(10) Pub. No.: US 2015/0137553 A1
(43) Pub. Date: May 21, 2015

(54) Car cap

(71) Applicant: Donald Lee Iman, Aurora, OR (US)

(72) Inventor: Donald Lee Iman, Aurora, OR (US)

(21) Appl. No.: 13/998,620

(22) Filed: Nov. 18, 2013

(51) Int. Cl. B60J 11/04

(52) U.S. Cl. CPC B60J 11/04
USPC 296/136.07

(57) ABSTRACT

The Car Cap is smaller, lighter, quicker and easier to place and secure then remove and store when not being used than any other external automobile sun cover on the market. Said cover is made of an elastic sun blocker material, 84% polyester 16% spandex and custom fitted to each make/model of car so it fits snuggly. Said cover is easily cared for since it is washable in any small non-commercial residential washing machine. When not in use it is stored in a small sack approximately 12 to 15 inches square and made of the same material as the body of said cover. The holding sack is positioned at the trunk end of said cover to help orient said cover front to back when being placed and to add to retention and anti-theft properties when the trunk is closed following placement of said cover. In addition there are two nylon holding straps with retention buckles one on each side of said holding sack to solidly secure said cover once the trunk of the car is closed over said holding sack and retention straps with attached buckles. Said cover has a hemmed slot at each sport mirror allowing said slot to stretch and fit over said sport mirrors snuggly to provide the final retention needed to secure said cover to the vehicle. The front of said cover can be placed under the front windshield wiper blades to help stabilize said cover in the event of high winds.

The Car Cap is smaller, lighter, quicker and easier to place and secure then remove and store when not being used than any other external automobile sun cover. Said cover is made of an elastic material, 84% polyester 16% spandex and custom fitted to each make/model of car so it fits the car snuggly. Said cover is easily cared for since it is washable in any small non-commercial domestic washing machine. When not in use said cover is stored in a small sack approximately 12 to 15 inches square depending on the size of the car being covered. Said sack is attached to and made of the same elastic material as the body of said cover. Said holding sack is positioned at the trunk end of said cover to help orient said cover when being placed and to add to retention and anti-theft properties when the trunk is closed following placement of said cover. There are two nylon holding straps with retention buckles attached to the trunk end of said cover to solidly secure said cover once the trunk of the car is closed over said holding sack and said retention straps with buckles. Said cover has a hemmed slot at each sport mirror allowing said slit to stretch and fit over said sport mirrors snuggly to provide retention needed to secure said cover to the vehicle. Said cover is now secure in winds of in excess of 40 miles per hour. The front of the cover can be placed under the windshield wiper blades to help stabilize said cover in the event of extreme high winds.

All existing external car covers either cover the entire car or are difficult to place and secure due to ribs or some other rigid device and are bulky to store when not in use. None are custom fitted to each make/model of automobile. No other car sun cover is made of an elastic material to achieve the snug look and fit of said cover. Materials used in the production of other sun covers makes them difficult to clean non-professionally let alone wash in a residential non-commercial washing machine. All interior sun shades do not stop the energy photons from the sun from passing through the auto glass and the interior of the automobile is still heated to unacceptable temperatures. Said high temperature results in damage to the interior structures and contents of the vehicle, as well as potentially injuring a returning occupant.

External car covers are generally not used unless the vehicle is to be left in the elements for an extended period of time because said covers are time consuming to place and difficult to secure to the vehicle making theft a real possibility. Interior sun shades are not efficient in reducing interior temperatures of an automobile when left in the sun.

Since The Car Cap is so light and easy to place and secure, said cover can be used when the car is to be left in the sun for only a brief period of time. As an exterior cover said cover minimizes the energy photons from the sun entering the car so no superheating of the interior structures occurs. This allows the owner of a vehicle to park in the sun and not under a tree which deposits debris on said car and encourages birds to defecate on the exterior and not suffer the discomfort and danger of a 200 degree F. interior upon their return. Said cover can be easily placed by a single person in 20 to 30 seconds and removed and stored in 15 to 20 seconds.

The elastic fabric (FIG. 1A) composes the bulk of said car sun cover and is a 4-way stretch sun blocker fabric. Said elastic material locks around the sport mirrors (FIG. 3D) using hemmed slots. Nylon retention straps with metal or plastic buckles (FIG. 2C) as well as said carrying sack (FIG. 2B), secure the back of said cover when the trunk lid is shut over them. No other existing car sun cover utilizes said retention straps with said buckles, said holding sack or sport mirror slots to secure the cover to the automobile preventing theft or loss due to high winds.

When placed properly said cover reduces the interior temperature of an automobile sitting in the sun to at or near the ambient temperature of the external air around said automobile. By stopping the light photons from passing through the window glass of said vehicle said cover prevents interior surfaces such as seats dashboard, steering wheel, etc. absorbing the energy of the photons from the sun. This can reduce the interior temperature of said vehicle by as much as 100*F on a hot sunny day.

Said cover will be made to fit individual body styles/sizes of different automobile makes/models. The retention devices will be adapted to work best for the make/model of the vehicle being fitted for said cover. Said cover is made from a pattern produced specifically for each car make/model. Said fabric is then cut to the desired pattern and the edges and seams are finished with a sewn hem. Slots for the sport mirrors are cut and hemmed. Said retention straps with metal/plastic buckles are then sewn to the body of said cover. Part of said pattern is an extended piece of material at the trunk end of of said cover between 24 and 30 inches long and 12 to 15 inches wide which is then sewn back over itself to form said holding sack for said cover.

Said basic fabric cover, sport mirror slots, holding sack and retention straps with buckles will be necessary for said cover to remain in place during normal use. Any additional locking or anti-theft devices as well as logos to individualize the cover for the purchaser or retailer are optional.

Velcro straps may be added to the front or back of said cover for added retention around windshield wipers apparatus or to the sides of said cover for added retention around automobile door handles. In the absence of a closing trunk lid suction cups could be added to said retention straps and said holding sack to temporarily hold said retention straps and said holding sack to inside of rear window of automobiles with hatchbacks until said hatchback is closed securing said cover. Magnetic devices could be added to aid in retention as well.

To place said cover on an automobile simply open the trunk of said car and position said holding sack in the area between the top of said trunk and the rear windshield of said car. This will orient said cover properly front to back. Remove said cover from said holding sack stretching said cover over the roof of the car. Place the sport mirrors through the appropriate retention slots in the said cover fabric. Return to the trunk of the car and position said retention straps and holding sack in the trunk and close the trunk lid. Said cover is now in place and secure. The front windshield wiper blades can be placed on top of said cover to assist in holding said cover in place on especially windy days.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1A illustrates an example of the exterior extensions of said cover on an automobile. Said cover extending to base of front windshield, base of side passenger and driver windows and junction of rear window and trunk lid of example vehicle.

FIG. 2B illustrates an example of the holding sack which is an extension of the said cover material folded back on itself then sewn to form said sack. When vehicle trunk lid is closed as in FIG. 1A said holding sack is positioned inside trunk space.

FIG. 2C illustrates an example of the two retention straps with buckles attached to said cover on either side of said holding sack. When vehicle trunk lid is closed as in FIG. 1A said retention straps are positioned inside trunk space to prevent removal of said cover while trunk is closed.

FIG. 3D illustrates an example of sport mirror retention slots having been stretched over said sport mirror and resting at base of said mirror assisting in retention of said cover on example vehicle.

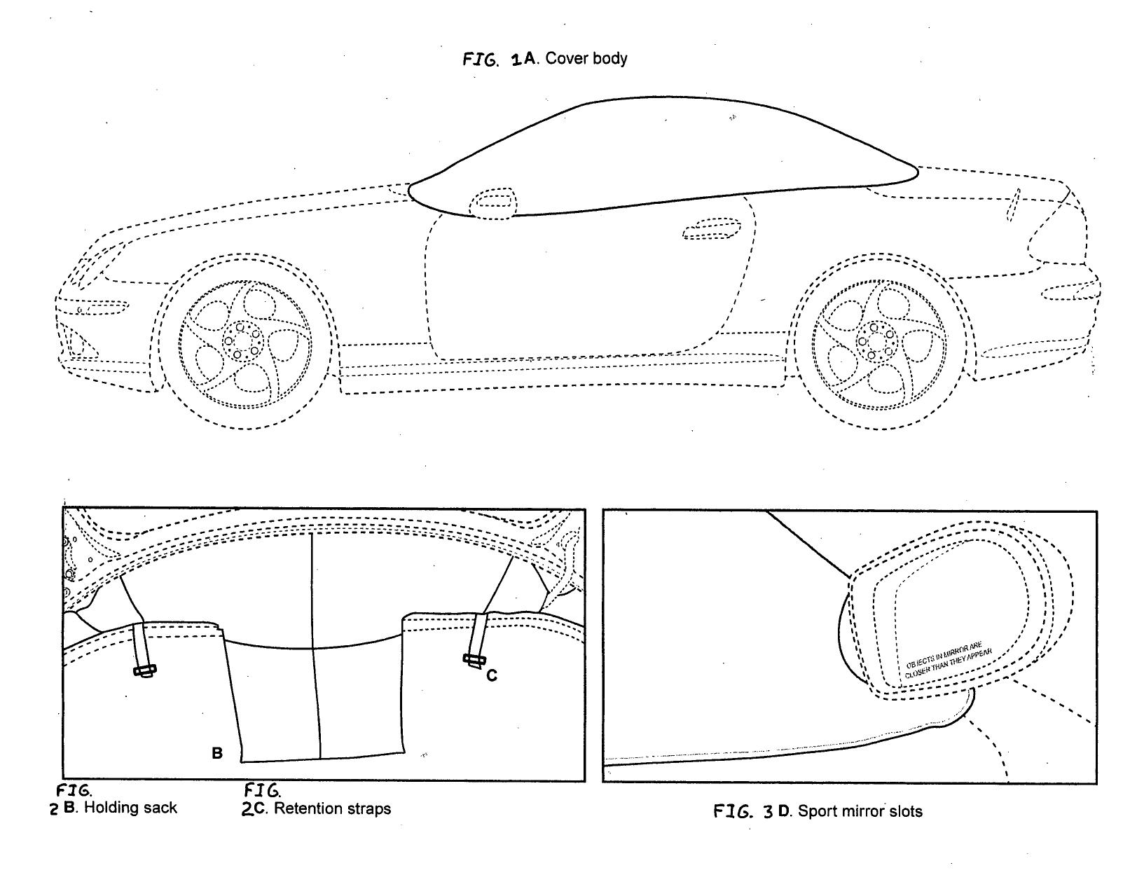

I claim:

1. An external automobile sun cover made with lightweight 4-way stretch sun blocker elastic fabric.

2. The cover of claim 1 fabric being 85% polyester and 15% spandex.

3. The cover of claim 1 having hemmed slots at automobile sport mirrors to aid in retention of said cover when placed over said sport mirrors.

4. The cover of claim 1 is custom fitted for each make/model of automobile for a snug fit.

5. The cover of claim 1 is fully washable in non-commercial residential washing machine.

6. A sack made of the same material as said cover and attached to said cover at trunk end of cover.

7. The sack of claim 6 being 12 to 15 inches square and large enough to store said cover in when not in use.

8. Nylon straps with metal/plastic buckles attached on either side of said holding sack and extending into trunk opening when said cover is placed on automobile.

9. The nylon straps of claim 8 provide retention and anti-theft properties of said cover when trunk lid is closed.
